(19) United States
(12) Patent Application Publication
(10) Pub. No.: US 2012/0314829 A1
(43) Pub. Date: Dec. 13, 2012

(54) THERMAL ENERGY INTEGRATION AND STORAGE SYSTEM

(75) Inventor: Sherrell R. Greene, Knoxville, TN (US)

(73) Assignee: UB-Battelle, LLC

(21) Appl. No.: 13/156,148

(22) Filed: Jun. 8, 2011

(51) Int. Cl. G21D 7/00

(52) U.S. Cl. 376/322

(57) ABSTRACT

A system that includes:
a container that contains an energy storage medium, wherein the energy storage medium comprises at least one liquid salt;
at least one thermal energy-generating reactor;
at least one first thermal energy loop coupling the container to the at least one thermal energy-generating reactor; and
at least one second thermal energy loop coupling the container to at least one thermal energy end-user.

### ACKNOWLEDGEMENT OF GOVERNMENT SUPPORT

This invention was made with government support under Contract No. DE-AC05-00OR22725 awarded by the U.S. Department of Energy. The government has certain rights in the invention.

### BACKGROUND

Numerous petrochemical refining processes require high-quality heat in the 600-700° C. range. For example, small reactor systems operating in the 750° C. range would be well suited for remote production of high-pressure steam to enable petroleum extraction from oil sands. Hydrogen production via high-temperature electrolysis and steam-methane reforming becomes practical at temperatures in the 800-850° C. range (and is currently produced via natural gas combustion). The attainment of reactor core outlet temperatures of 900-1000° C. would enable a variety of thermal chemical processes for the production of hydrogen from water, gasification of hard coal and lignite, etc. The integration of high-temperature reactors with compatible thermal energy storage systems would significantly enhance the utility of such systems and expand the applications opportunities for nuclear energy. Thus, the development of a reliable, economical, and flexible nuclear energy system capable of delivering heat at 600-1000° C. would revolutionize highly efficient electrical power production and the production of liquid fuels for transportation and other applications.

### SUMMARY

Disclosed herein are integrated thermal energy storage systems. In certain embodiments these systems deliver thermal energy at 600-1000° C. to an end-user.

One embodiment of a system comprises:

a container that contains an energy storage medium, wherein the energy storage medium comprises at least one liquid salt;

at least one thermal energy-generating reactor;

at least one first thermal energy loop coupling the container to the at least one thermal energy-generating reactor; and

at least one second thermal energy loop coupling the container to at least one thermal energy end-user.

Another embodiment disclosed herein is a system comprising:

a container configured for containing an energy storage medium, wherein the energy storage medium comprises at least one liquid salt having a working temperature of at least 300° C.;

a thermal energy management subsystem comprising at least one salt-tolerant solid structure located within the container; at least one first heat exchange interface located within the container and coupled to a thermal energy source; and

at least one second heat exchange interface located within the container and coupled to a thermal energy end-user.

Also disclosed herein is a method for storing and distributing thermal energy from more than one nuclear reactor, the method comprising:

generating thermal energy transport streams from more than one nuclear reactor, wherein the thermal energy transport streams are at a nuclear reactor outlet temperature;

introducing the thermal energy transport streams into a container that holds a thermal energy storage medium, wherein the thermal energy storage medium comprises at least one liquid salt at a thermal energy storage temperature, and wherein the nuclear reactor outlet temperature is higher than the thermal energy storage temperature;

within the container, transferring thermal energy from the thermal energy transport streams to the thermal energy storage medium; and

transferring thermal energy from the thermal energy storage medium to an end-user heat load.

The foregoing will become more apparent from the following detailed description, which proceeds with reference to the accompanying figures.

### BRIEF DESCRIPTION OF THE DRAWINGS

FIG. 1 is a perspective view of an embodiment of a thermal energy integration and storage system as described herein.

FIG. 2 is a schematic representation of an embodiment of a thermal energy integration and storage system showing examples of energy charging subsystems and energy extraction subsystems.

FIG. 3 depicts tables showing physical and process parameters of one embodiment of a system as described herein.

FIGS. 4-7 are schematic representations of several embodiments of thermal energy integration and storage system showing examples of energy charging subsystems and energy extraction subsystems.

### DETAILED DESCRIPTION

Described herein are systems in which at least one reactor unit charges its thermal energy into a container that holds a thermal energy storage medium, which in turn serves as a thermal energy reservoir for process heat or power production customer. Such systems are referred to herein as a “salt vault.” In certain embodiments, the system involves one or more nuclear reactors and one or more energy end-users.

Depending on the physical size of the salt vault, the specific salt selected for the salt vault working fluid, and the working temperature range of the system (defined to be the difference between the highest and lowest bulk fluid temperatures allowed in the salt vault energy storage salt medium), the salt vault is capable of storing MWh-to-MWd of thermal energy.

The capability to cluster multiple reactors to meet energy demands greater than what could be met by a single nuclear reactor unit is an important design consideration for small modular nuclear reactors (SMRs), and could potentially be important for very large nuclear power plants as well. This is certainly the case for any reactor concept designed for both electricity production and process heat applications. However, numerous questions and issues arise whenever multiple reactor units are interconnected. Only integration methods that do not compromise system safety or reliability can be considered. The interconnection or “clustering” of multiple reactor units to drive shared electrical power conversion systems has been widely discussed by reactor vendors and advanced concept developers for many years. However, the correct approach for clustering multiple small reactor units to meet intermediate-to-large process heat loads has received much less attention. The salt vault thermal energy integration and storage system described here provides the ability to meet larger thermal energy loads than can be met by a single reactor.

The interconnection of multiple nuclear reactors to meet larger energy demands than can be met by a single reactor can entail a level of interaction and potential inter-dependency between the reactors that can be undesirable from both the operations and safety standpoints. A unique feature of the thermal energy integration and storage system described here is that it enables one to harness and integrate the energy of multiple reactor units, while avoiding the need to directly interconnect the cooling and energy removal systems of the reactors. Thus the probability of an operational transient or accident in one reactor to impact another reactor in the cluster is significantly reduced. The large thermal storage mass in the salt vault effectively “buffers” or “isolates” the multiple reactor units while receiving and integrating the energy they produce.

One traditional challenge of nuclear energy process heat and power production applications is the need for the reactors to accommodate variations in the end-user energy demand, without forcing undue operational transients on the reactors. A major advantage of the thermal energy integration and storage system described here is the ability to buffer the nuclear reactors to which it is interfaced from variations in customer load demand. Depending on the size of the salt vault, the working salt selected for the salt vault, and working temperature range specified for the salt vault, major variations in customer demand—up-to and including complete loss of load—could be accommodated. Such load variations would, therefore, not result in the need for immediate or prompt action on the part of the reactor systems to avoid undesirable reactor transients. This attribute also has the potential to reduce the overall probability and severity of some types of reactor accidents originating from rapid loss of load transients, station blackout accidents, and loss of decay heat removal accidents.

One of the traditional challenges in interfacing energy load demands (especially process heat load demands) to nuclear power plants is the possibility that interruptions in reactor operations (planned or unplanned) can have major disruptive impacts on the energy demand customer's operations. The thermal energy integration and storage systems described here provide multiple benefits with regard to this problem. First, with regard to un-anticipated reactor transients and shutdowns, the energy integration and storage system can be optimized (salt vault size, working salt, and working temperature range) such that reactor operations transients, up-to and including reactor shutdown, do not result in an immediate need to shut-down customer operations. This affords time for an orderly and “gentle” termination of customer operations. The salt vault could be sized to provide several hours of time to accommodate termination of customer operations. Second, because the thermal energy integration and storage system enables the clustering of multiple reactor units, thus enabling energy supply strategies in which an outage at a single unit can be accommodated by slightly increasing the operational power at the remaining reactor units. Thus routine reactor maintenance and outage operations can proceed with no impact on the energy customers operations.

The systems described herein may be designed to store various amounts of thermal energy. The thermal energy storage capacity of the system is a function of the end-user's process heat load and the end-user's tolerance to energy supply interruptions. The thermal energy storage capacity directly impacts the time required to heat the salt vault to operational temperatures from a cold start. The thermal energy storage capacity also directly impacts the time for the salt vault to begin solidifying following a reactor disruption or shutdown. In certain embodiments, the systems can store 10 to 1,000 MWt-hr of thermal energy, more particularly 100 to 500 MWt-hr of thermal energy, while operating over a temperature range of 500° C. to 600° C. For example, a salt vault sized to store 125 MWt-hr of thermal energy could absorb or deliver 1 reactor-hr of the thermal output of a single 125 MWt reactor unit. Depending on the salt selected, the salt vault operating temperature may be, for example, from 300 to 1000° C., more particularly 500 to 1000° C. The operating temperature (i.e., the working temperature) of the salt vault is the bulk temperature of the salt in the container. During operation the operating temperature in the salt vault may fluctuate while meeting the end-user's energy demands. For instance, a swing of perhaps 100° C. might be allowable in some applications, while a more narrow swing (e.g., 20° C.) might be required by other customers. The salt vault can accept energy above the operating temperature of the salt vault. The salt would remain a liquid a few hundred degrees below the lower temperature limit, and would not boil unless temperatures several hundreds of degrees above the upper temperature limit were somehow achieved—thus providing a high level of functionality, reliability, and safety.

The thermal energy stored in the salt vault can be supplied to a variety of end-users. Illustrative end-users include H₂ production and coal gasification (process heat requirements of 650-1000° C.), steam reforming of natural gas and biomass gasification (process heat requirements of 500-900° C.), cogeneration of electricity and steam (process heat requirements of 350-800° C.), oil shale/sand processing (process heat requirements of 300-600° C.), and petroleum refining (process heat requirements of 250-550° C.).

### Container

The salt vault container may be of any desired size and shape. In certain embodiments, the internal volume of the container may be 500 to 5000 m³. The container may be any shape. In certain embodiments the shape would be optimized to reduce heat loss through the container walls to the surroundings, while accommodating the various internal heat exchangers, piping, pumps/stirring systems, and thermal management components. A cylindrical shape is one particular embodiment, although cubes, cones and toroidal shapes could also be employed. The container may be constructed from any appropriate material for specific applications. The materials of construction depend upon the operating temperate range and the specific salt employed. There are both mechanical integrity and chemical compatibility considerations. Illustrative materials include stainless steel, high-nickel alloys such as Alloy-N, graphite, carbon-carbon composites, and SiC. The container may be insulated, and may be placed either above or below ground. For example, the internal and/or external surfaces of the container may be insulated to reduce undesirable energy losses from the container. Preferably, the insulating material is tolerant of liquid salts. Monitoring and control instrumentation may also be associated with the container. Such instrumentation may include salt and salt container temperature monitors at various locations around the salt vault, flow rate meter measuring flows into and out of the salt vault for directly coupled systems, heat exchanger temperature and flow instrumentation measuring heat exchanger inlet and outlet conditions (flowing salt and structural), pump or stirring motor status instrumentation, and chemical property measurement devices to measure the pH, chemical composition, etc. of the salt itself. The system may also include electrically-heated or gas-fired trace heaters positioned in the salt or on the inner or outer salt vault container surfaces, heat exchangers, and connected piping to control the freeze/thaw behavior of the salt-based energy storage medium. For example, the heaters could be used to selectively control heating and melting of localized regions of the salt and/or phase and control the thaw rate of selected heat exchangers or piping loops. The system may include more than one container that holds the energy storage medium.

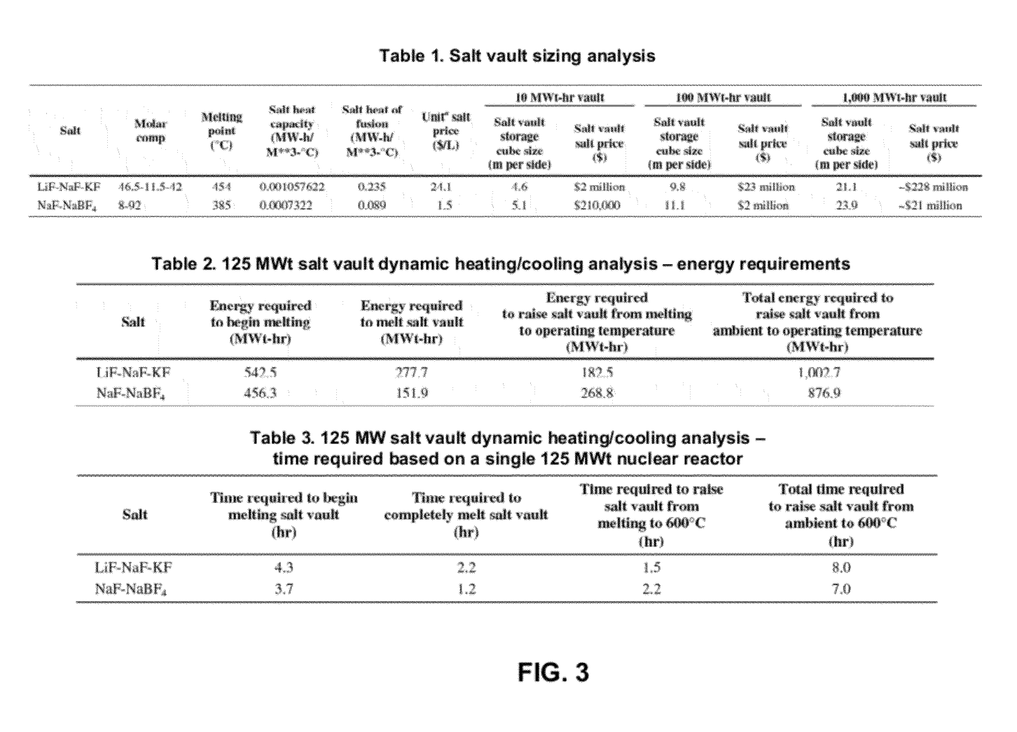

The physical size of the container does not have to be large to deliver significant amounts of energy. A cubic container measuring 10 to 11 m per side would be sufficient to store 100 MWt-hours of energy, and a cubic container measuring 21 to 24 m per side would be sufficient to store 1,000 MWt-hours of energy (see Table 1 in FIG. 3).

### Energy Storage Medium for Container

In certain embodiments any liquid salt may be used as the energy storage medium. Different halide salts may be used as the energy storage medium in different embodiments of the concept. However, salts with low vapor pressure (e.g., <0.1 to ˜10.0 mm Hg at 900° C.), high volumetric heat capacity (e.g, 2500 to 5000 kJ/m³-° C.), and low corrosive activity are most desirable because they enable compact, highly efficient, low-pressure energy storage and transport systems. Ideally, the melting point of the liquid salt should be lower than that of the primary coolant for the reactor(s) for operational flexibility. The boiling point of the liquid salt should be significantly higher than that of the reactor(s) operating temperature. In certain embodiments, the boiling point of the liquid salt may be, for example, from 1300 to 1600° C.

Preferred liquid molten salts include a halide salt (e.g., fluoride salt or chloride salt), a potassium salt, a sodium salt, a nitrate salt or mixtures thereof. Especially preferred are halide salts, particularly fluoride salts. Fluoride salts generally have low vapor pressures, high volumetric heat capacities, and offer working temperatures of 500° C. to 1000° C. and higher. In certain embodiments, the fluoride salts are ionic compounds formed from the combination of a halogen and another element, particularly alkali metals or alkaline earths. Illustrative salts include LiF, BeF₂, KF, NaF, ZrF₄, RbF, sodium nitrate, potassium nitrate, and mixtures thereof.

### Thermal Management Subsystem

In addition to the liquid salt, the container may include at least one solid structure to enhance the system's energy storage and heat transfer performance. The thermal management subsystem could be employed to alter the dynamic freeze/thaw behavior of the liquid salt by storing energy or channeling energy to localized regions of the bulk salt in the container or structures within the salt vault container, and modify and control internal circulation patterns and energy distribution phenomena. Illustrative solid structures include those comprised of high-nickel alloy, graphite, carbon-carbon composite, SiC composite, other salt-tolerant materials, or a combination thereof. The solid structure may assume any suitable shape such as, for example, solid or hollow cylinders, honeycomb structures, or flat planar structures. In certain embodiments, the thermal management subsystem could include independent pumps and/or impellor-driven devices to stir and enhance internal flow distribution between various locations in the bulk liquid salt, as well as trace heaters for selective heating of salt and structures.

### Thermal Energy Source

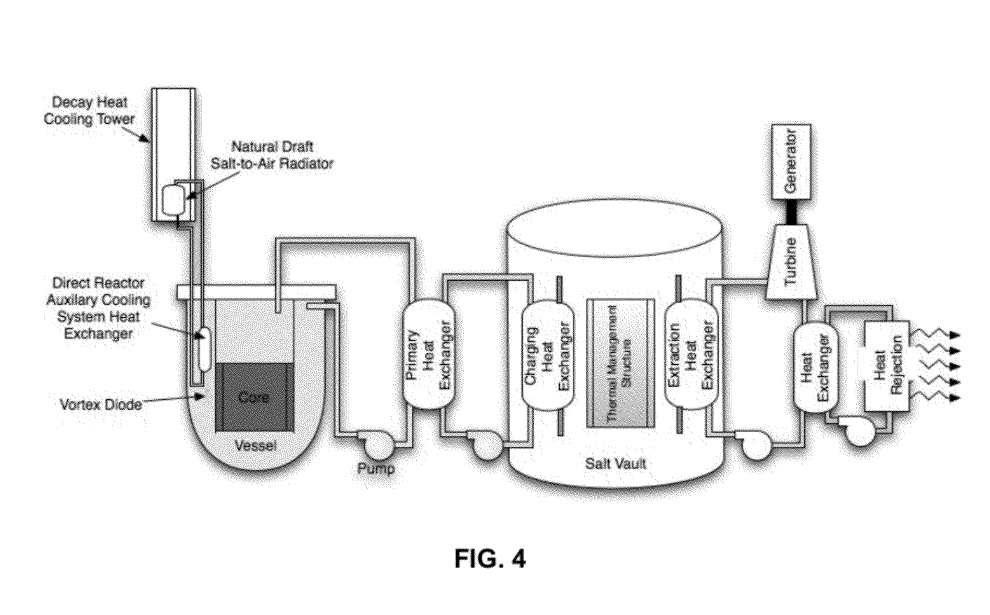

The thermal energy source may be a thermal energy-generating reactor, a solar energy source, a fossil fuel source, and/or a fusion energy source. Illustrative thermal energy-generating reactors include nuclear reactors, including light-water cooled, heavy-water cooled, gas-cooled, liquid-metal cooled, halide salt-cooled, and molten salt fueled/cooled reactors. In certain embodiments, the nuclear reactor is a halide salt-cooled (particularly fluoride salt-cooled), advanced high temperature reactor. For example, a liquid fluoride salt-cooled reactor may also include coated particle fuels and graphite moderator materials, with primary system pressures near atmospheric pressure and at coolant temperatures of 600 to 1000° C. In certain embodiments of such reactors fission occurs within the nuclear fuel and thermal energy is transferred to flowing reactor coolant, heating the salt to approximately 700° C. The reactor coolant salt then flows into a primary heat exchanger where the heat is transferred to an intermediate loop-secondary liquid salt. The reactor coolant salt then flows back to the reactor core. The clean salt in the secondary heat transport system (also referred to herein as the intermediate reactor cooling loop) transfers the heat from the primary heat exchanger to the salt vault system described herein. An example of a halide salt-cooled (particularly fluoride salt-cooled) advanced high temperature reactor is shown in FIGS. 4-7. Other examples of halide salt-cooled (particularly fluoride salt-cooled), advanced high temperature reactor are described, for example, in Alekseev et al, “MARS Low-Power Liquid-Salt Micropellet-Fuel Reactor”, Atomic Energy, Vol. 93, No. 1, 2002; and Ingersol et al., “Status of Preconceptual Design of the Advanced High-Temperature Reactor (AHTR), ORNL/TM-2004/104, Oak Ridge National Laboratory, May 2004.

In one embodiment, the halide salt-cooled (particularly fluoride salt-cooled), advanced high temperature reactor may have a reactor power level of 100-150 MWt, a height of 7-10 m, a width of 3-5 m, a core outlet temperature of 600-800° C., passive decay heat removal (via at least one reactor in-vessel direct reactor auxiliary cooling system (DRACS) heat exchanger) and at least one reactor in-vessel primary heat exchanger.

### Energy Charging Subsystem

The system includes an energy charging subsystem that includes one or more open or closed pumped loops that convey thermal energy from one or more thermal energy sources (e.g., nuclear reactors or other thermal energy source) to the container. Each energy charging subsystem loop may contain heat exchanger(s), pump(s), valve(s) and assorted instrumentation for monitoring and control of energy flow into the container.

The energy charging loop(s) may include one or more heat exchangers that interface with the thermal energy source. In certain embodiments the reactor-interface heat exchanger may be located within the reactor vessel. In other embodiments the reactor-interface heat exchanger may be thermally coupled to the reactor via an externally-located intermediate reactor cooling loop.

In certain embodiments, the energy charging loop is a closed loop that includes a container-interface heat exchanger immersed in the energy storage medium of the container. The working fluid in a closed energy charging loop would be distinct and independent from the working fluid in the container (and possibly from the reactor), could comprise liquid water, gas, liquid metal, or liquid salt—depending on the type of reactor system to which the thermal energy integration and storage system is interfaced.

In other embodiments the energy charging loop is an open loop wherein there is no container-interface heat exchanger in the container. The container's energy storage medium would be the charging loop's working fluid and would be directly conveyed to and from the interfacing reactor system(s). For example, the energy charging loop may include pipes directly coupled with the energy storage medium in the container.

### Energy Extraction Subsystem

The system also includes an energy extraction subsystem that includes one or more open or closed pumped loops that convey thermal energy from the container to one or more end-users. Examples of such end-users could be process-heat customers and/or electricity generation customers. Each energy extraction subsystem loop may contain heat exchangers, pumps, valves and assorted instrumentation for monitoring and control of energy flow out of the container.

In an embodiment in which the energy extraction loop is closed there is a container-interface heat exchanger immersed in the energy storage medium. The working fluid in a closed energy charging loop would be distinct and independent from the working fluid in the container, and could comprise liquid water, gas, liquid metal, or liquid salt.

In other embodiments the energy extraction loop is open loop wherein there is no container-interface heat exchanger in the container. The salt vault container's energy storage medium would be the extraction loop's working fluid and would be directly conveyed to and from the interfacing end-user applications (process heat, electrical power production, etc.). For example, the energy extraction loop may include stubbing pipes fluidly coupled with the energy storage medium in the container.

### ILLUSTRATIVE EMBODIMENTS

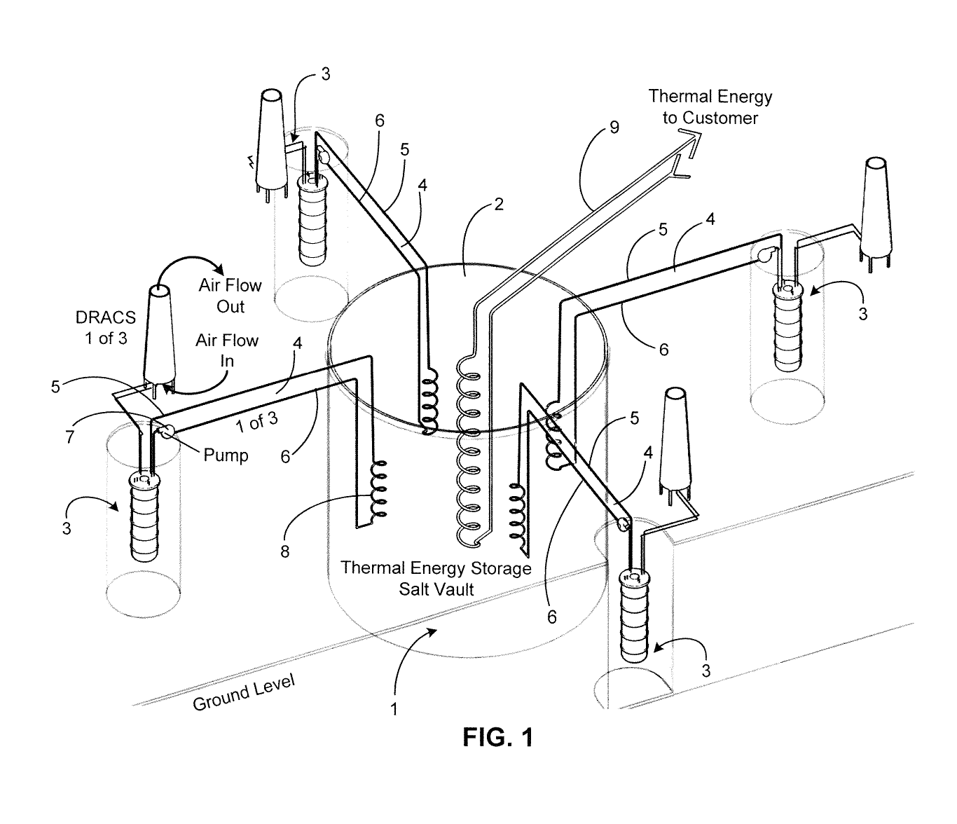

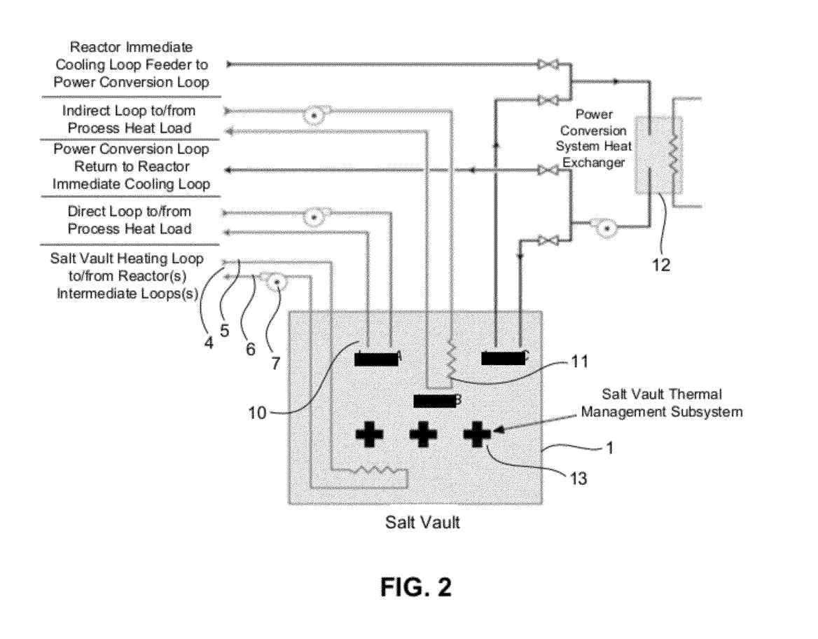

Embodiment of a thermal energy integration and storage system are depicted in FIGS. 1, 2 and 4-7. FIG. 1 is a depiction of the thermal energy integration and storage salt vault system interfaced with four nuclear reactor units. The salt vault concept depicted in FIG. 1 employs charging heat exchangers (one from each reactor unit) and one demand-side heat exchanger to convey the process heat to the customer (or potentially to a power conversion system). There are a variety of process heat applications for nuclear reactors and potential methods for extracting energy from the salt vault. While it would be desirable from a thermal efficiency standpoint to locate the reactor modules and salt vault energy storage system as close as possible to the process heat load, in practice it might be necessary to “ferry” heat for distances of a few kilometers. FIG. 2 is a more detailed version of FIG. 1 that depicts some of these energy extraction and transport options.

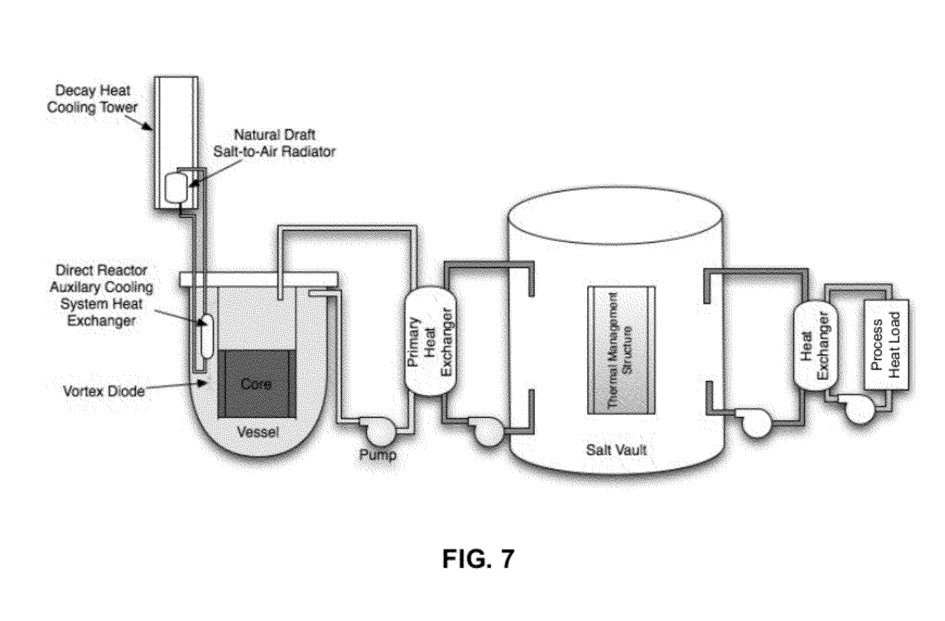

In particular, the system includes a container 1 for holding the thermal energy storage medium 2. Coupled to the container 1 are four nuclear reactors 3. Each nuclear reactor 3 is coupled to the container 1 via a thermal energy charging loop 4. The energy charging loop 4 includes a first “hot” leg 5 for conveying thermal energy from the reactor 2 to the energy storage medium 2. The energy charging loop 4 also includes a second “cold” leg 6 for return to the reactor 3. A pump 7 for conveying a thermal energy transfer working fluid around loop 4 is shown associated with the second leg 6, but the pump could be located at any position on the energy charging loop 4. The loop 4 also includes a container-interface heat exchange module 8. The container-interface heat exchange module 8 may include at least one heat exchanger (for a closed loop) or stubbed pipes (for an open loop). For example, FIGS. 4-6 depict an energy charging heat exchanger as module 8. FIG. 7 depicts stubbing pipes on the energy charging side of the salt vault as module 8. In the embodiment shown in FIG. 7 the salt in the salt vault is also the working fluid for a primary heat exchanger that interfaces with and cools a nuclear reactor. The working fluid for the primary heat exchanger/reactor loop is separate from the working fluid for the salt vault. The module 8 may be located at any position within the container that is conducive for heat transfer.

Intermediate loop working fluid from reactor 3 is conveyed via leg 5 to the energy storage medium 2. The heat from the heated working fluid is transferred to the energy storage medium 2 in the container 1. The cooler thermal energy working fluid is then conveyed back to the reactor 3 via return leg 6 for re-circulation and reheating.

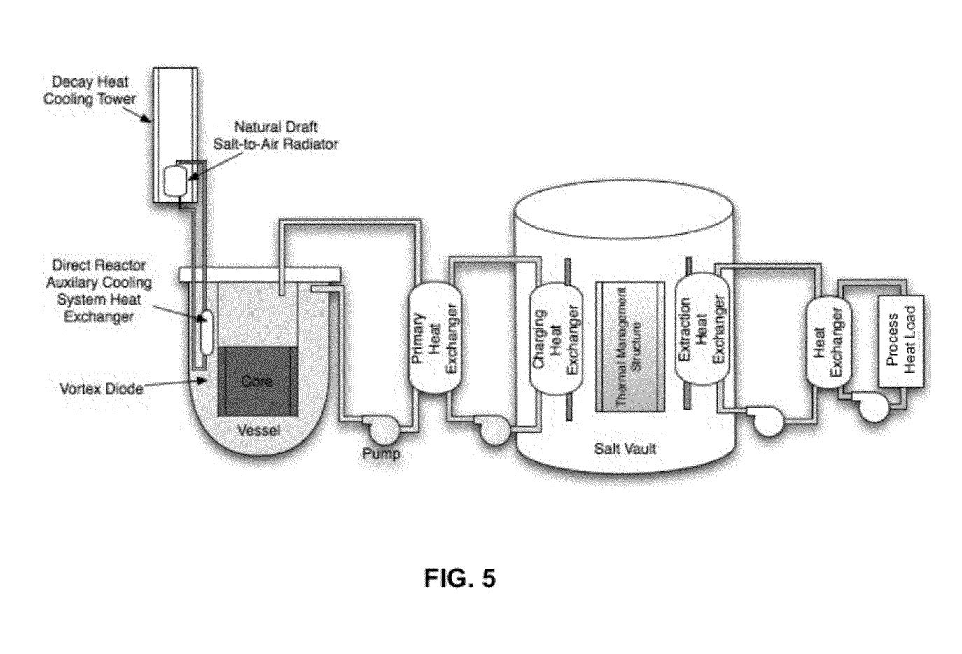

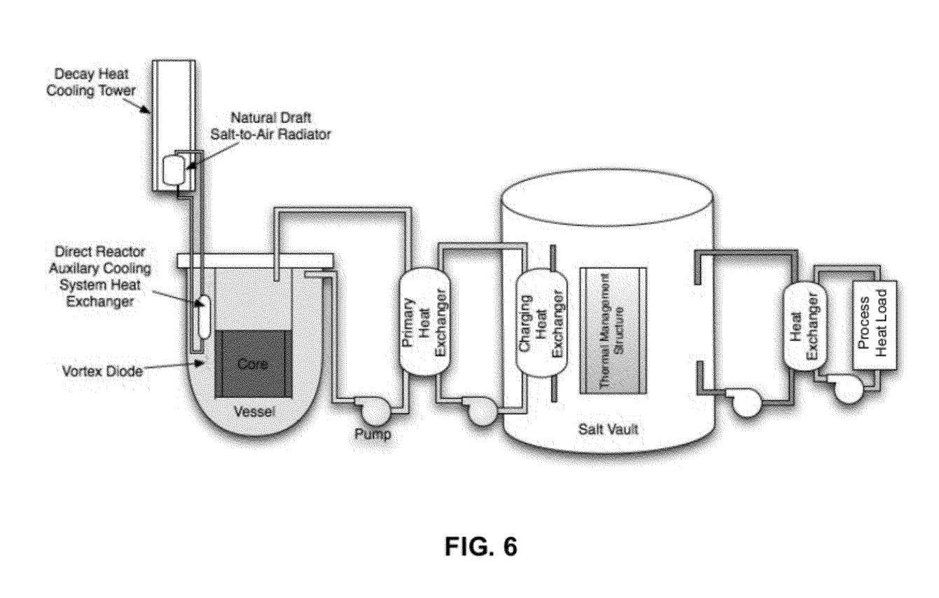

The system also includes a thermal energy extraction loop 9 for conveying the thermal energy stored in the thermal energy storage medium 2 to an end-user. FIG. 2 shows several embodiments of a thermal energy extraction loop. Some reactor process heat applications may be able to directly use the salt in the salt vault as the heat transport (i.e. working) fluid in a directly coupled process heat demand loop (Loop A in FIG. 2; stubbed pipes in FIGS. 6 and 7). Accordingly, Loop A includes stubbed piping 10 fluidly coupled to the energy storage medium 2. Other process heat applications might require an additional degree of isolation from the reactor intermediate cooling loop. Such applications could be handled via a second indirectly coupled process heat demand loop (Loop B in FIG. 2; FIGS. 4 and 5) that uses a demand-side heat exchanger 11 in the salt vault.

Electrical power conversion subsystems may be interfaced directly with the salt vault energy storage medium, or directly to the reactor intermediate heat transport loops. FIG. 2 depicts such a system, in which a dedicated energy extraction loop for electrical power production is added (Loop C). Salt from the salt vault is pumped via Loop C through a power conversion heat exchanger 12 (where it transfers energy to the power conversion system working fluid) and then back either to the salt vault or, conceivably, directly to the intermediate heat transfer loop. Thus the power conversion system could be configured to draw its energy directly from one or more reactors or from the entire reactor cluster via the salt vault.

The system may also include thermal management subsystem solid structures 13 as described above.

Tables 2 and 3 in FIG. 3 summarize the results of an analysis of the energy and time required to raise a salt vault sized to store 125 MW (1 reactor-hr) of reactor thermal energy from a starting temperature of 20° C. to the fluoride salt melting temperature, completely melt the salt, and raise the temperature of the entire salt vault from the melting temperature to the assumed 600° C. salt vault operating temperature. Table 2 presents the results in terms of energy required. Table 3 presents the results in terms of reactor-hours required assuming the entire thermal output of a single 125 MWt reactor module was is to charge the salt vault. The conclusion from analysis of Table 3 is that the time for the salt vault to reach operational temperatures is reasonable (˜7-8 hr or one shift), given that one would not expect the reactor unit and the salt vault to undergo such start-up transients on a frequent basis.

It should be recognized that the illustrated embodiments are only preferred examples of the invention and should not be taken as limiting the scope of the invention.

What is claimed is:

1. A system comprising:
a container that contains an energy storage medium, wherein the energy storage medium comprises at least one liquid salt;
at least one thermal energy-generating reactor;
at least one first thermal energy loop coupling the container to the at least one thermal energy-generating reactor; and
at least one second thermal energy loop coupling the container to at least one thermal energy end-user.

2. The system of claim 1, wherein the container comprises an insulated vessel.

3. The system of claim 1, further comprising at least one salt-tolerant solid structure located within the container and configured to optimize the energy storage medium function.

4. The system of claim 3, wherein the at least one salt-tolerant solid structure comprises high-nickel alloy, graphite, a carbon-carbon composite, a SiC composite, or a combination thereof.

5. The system of claim 1, wherein the at least one liquid salt comprises a halide salt, a potassium salt, a sodium salt, a nitrate salt or mixtures thereof.

6. The system of claim 1, wherein the at least one liquid salt comprises a fluoride salt.

7. The system of claim 1, wherein the at least one thermal energy-generating reactor comprises a nuclear reactor.

8. The system of claim 7, wherein the nuclear reactor comprises a liquid fluoride salt-cooled nuclear reactor.

9. The system of claim 1, wherein the system includes more than one thermal energy-generating reactor and each thermal energy-generating reactor comprises a nuclear reactor.

10. The system of claim 1, wherein the first thermal energy loop comprises at least one first heat exchange interface associated with the at least one thermal energy-generating reactor, and at least one second heat exchange interface associated with energy storage medium in the container.

11. The system of claim 1, wherein the first thermal energy loop contains a thermal energy exchange working fluid selected from liquid water, gas, liquid metal or liquid salt.

12. The system of claim 1, wherein the first thermal energy loop is fluidly coupled to the container so that the at least one liquid salt of the energy storage medium is also a thermal energy exchange working fluid for the first thermal energy loop.

13. The system of claim 6, wherein the at least one thermal energy-generating reactor comprises a liquid fluoride salt-cooled nuclear reactor.

14. The system of claim 1, wherein the energy storage medium has an operating temperature of 600° C. to 1000° C.

15. The system of claim 13, wherein the reactor has a reactor power level of 100-150 MWt, a height of 7-10 m, a width of 3-5 m, a core outlet temperature of 600-800° C., at least one reactor in-vessel passive decay heat removal heat exchanger, and at least one reactor in-vessel primary heat exchanger.

16. The system of claim 1, wherein the at least one thermal energy end-user is at least one of H₂ production, coal gasification, steam reforming of natural gas, biomass gasification, cogeneration of electricity and steam, oil shale/sand processing, or petroleum refining.

17. A system comprising:
a container configured for containing an energy storage medium, wherein the energy storage medium comprises at least one liquid salt having a working temperature of at least 300° C.;
a thermal energy management subsystem comprising at least one salt-tolerant solid structure located within the container;
at least one first heat exchange interface located within the container and coupled to a thermal energy source; and
at least one second heat exchange interface located within the container and coupled to a thermal energy end-user.

18. The system of claim 17, wherein the at least one salt-tolerant solid structure comprises graphite, a carbon-carbon composite, a SiC composite, or a combination thereof.

19. A method for storing and distributing thermal energy from more than one nuclear reactor, the method comprising:
generating thermal energy transport streams from more than one nuclear reactor, wherein the thermal energy transport streams are at a nuclear reactor outlet temperature;
introducing the thermal energy transport streams into a container that holds a thermal energy storage medium, wherein the thermal energy storage medium comprises at least one liquid salt at a thermal energy storage temperature, and wherein the nuclear reactor outlet temperature is higher than the thermal energy storage temperature;
within the container, transferring thermal energy from the thermal energy transport streams to the thermal energy storage medium; and
transferring thermal energy from the thermal energy storage medium to an end-user heat load.

20. The method of claim 19, wherein the thermal energy medium in the container stores 10 to 1,000 MWt-hr of thermal energy.
